(19) United States
(12) Patent Application Publication
(10) Pub. No.: US 2024/0211668 A1
(43) Pub. Date: Jun. 27, 2024

(54) METHOD AND SYSTEM FOR AUGMENTING DATA BY SYNTHESIZING MEASUREMENT DATA AND SIMULATION DATA

(71) Applicant: Samsung Electronics Co., Ltd., Suwon-si (KR)

(72) Inventors: Joosung LEE, Suwon-si (KR); Jinwoo KIM, Suwon-si (KR); Bogyeong KANG, Suwon-si (KR); Jaemyung CHOE, Suwon-si (KR)

(73) Assignee: Samsung Electronics Co., Ltd., Suwon-si (KR)

(21) Appl. No.: 18/498,315

(22) Filed: Oct. 31, 2023

(30) Foreign Application Priority Data
Dec. 27, 2022 (KR) 10-2022-0186381

(51) Int. Cl. G06F 30/3308; G06F 30/31

(52) U.S. Cl. CPC G06F 30/3308; G06F 30/31; G06F 2119/10

(57) ABSTRACT

A method of augmenting training data for a semiconductor process modeling includes obtaining a simulation input data set and a measurement data set, obtaining a simulation output data set generated based on performing simulation based on the simulation input data set, extracting reference noise information associated with the measurement data set from the measurement data set, extracting distribution information associated with each simulation case included in the simulation output data set based on synthesizing the reference noise information and the simulation output data set, generating a noise simulation data set based on sampling data based on the distribution information, and generating a synthesized data set based on synthesizing the simulation input data set, the noise simulation data set, and the measurement data set.

### CROSS-REFERENCE TO RELATED APPLICATION

This application is based on and claims priority under 35 U.S.C. § 119 to Korean Patent Application No. 10-2022-0186381, filed on Dec. 27, 2022 in the Korean Intellectual Property Office, the disclosure of which is incorporated by reference herein in its entirety.

### BACKGROUND

The inventive concepts relate to data augmentation methods, and more particularly, to methods of augmenting data by using synthesized data, in which measurement data and simulation data are synthesized in a semiconductor field.

To generate a machine learning model having high consistency and good generalization, learning data reflecting various cases may be required. However, in the case of the semiconductor field, it may be difficult to generate an appropriate machine learning model due to the lack of amount and diversity of measurement data.

### SUMMARY

Some example embodiments of the inventive concepts provide a method of generating simulation data reflecting uncertainty of measurement data and augmenting the measurement data.

The issues to be solved by the technical idea of the inventive concepts are not limited to the above-mentioned issues, and other issues not mentioned may be clearly understood by one of ordinary skill in the art from the following descriptions.

According to some example embodiments of the inventive concepts, a method of augmenting training data for a semiconductor process modeling may include obtaining a simulation input data set and a measurement data set, obtaining a simulation output data set generated by performing simulation based on the simulation input data set, extracting reference noise information associated with the measurement data set from the measurement data set, extracting distribution information associated with each simulation case included in the simulation output data set based on synthesizing the reference noise information and the simulation output data set, generating a noise simulation data set based on sampling data based on the distribution information, and generating a synthesized data set based on synthesizing the simulation input data set, the noise simulation data set, and the measurement data set.

According to some example embodiments of the inventive concepts, a computer-readable non-transitory storage medium may be configured to store instructions executable by a processor to cause the processor to perform training data augmentation for semiconductor process modeling, wherein the training data augmentation for the semiconductor process modeling may include obtaining simulation recipe information, generating a first simulation input data set based on sampling values corresponding to input variable information included in the simulation recipe information, generating a first simulation output data set based on performing simulation based on the first simulation input data set, and generating a first synthesized data set based on synthesizing the first simulation input data set and the first simulation output data set.

According to some example embodiments of the inventive concepts, a system may include a memory configured to store a program for augmenting the data, and a processor configured to execute the program to: obtain a first simulation input data set and a measurement data set, obtain a first simulation output data set based on performing simulation based on the first simulation input data set, extract reference noise information associated with the measurement data set from the measurement data set, extract distribution information associated with each simulation case included in the first simulation output data set based on synthesizing the reference noise information and the first simulation output data set, generate a noise simulation data set based on sampling data based on the distribution information, and generate a first synthesized data set based on synthesizing the first simulation input data set, the noise simulation data set, and the measurement data set.

### BRIEF DESCRIPTION OF THE DRAWINGS

The example embodiments will be more clearly understood from the following detailed description taken in conjunction with the accompanying drawings in which:

FIG. 1 is a block diagram of a system according to some example embodiments;

FIG. 2 is a block diagram of a data augmentation module according to some example embodiments;

FIG. 3 illustrates diagrams of a simulation data set according to some example embodiments;

FIG. 4 is a diagram of measurement data according to some example embodiments;

FIGS. 5A, 5B, and 5C are diagrams of a method of extracting noise information from measurement data, according to some example embodiments;

FIG. 6 is a flowchart of a method of augmenting data, according to some example embodiments;

FIG. 7 is a flowchart of a method of extracting noise information from measurement data, according to some example embodiments;

FIG. 8 is a flowchart of a method of generating noise simulation data according to some example embodiments;

FIG. 9 is a block diagram of a system according to some example embodiments;

FIG. 10 is a flowchart of a method of augmenting data, according to some example embodiments;

FIG. 11 is a flowchart of a method of augmenting data, according to some example embodiments; and

FIG. 12 is a block diagram of a system according to some example embodiments.

### DETAILED DESCRIPTION

Hereinafter, some example embodiments of the inventive concepts are described in detail with reference to the accompanying drawings. When descriptions are given with reference to drawings, identical or corresponding components may be given with identical drawing reference numbers, and duplicate descriptions thereof are omitted.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

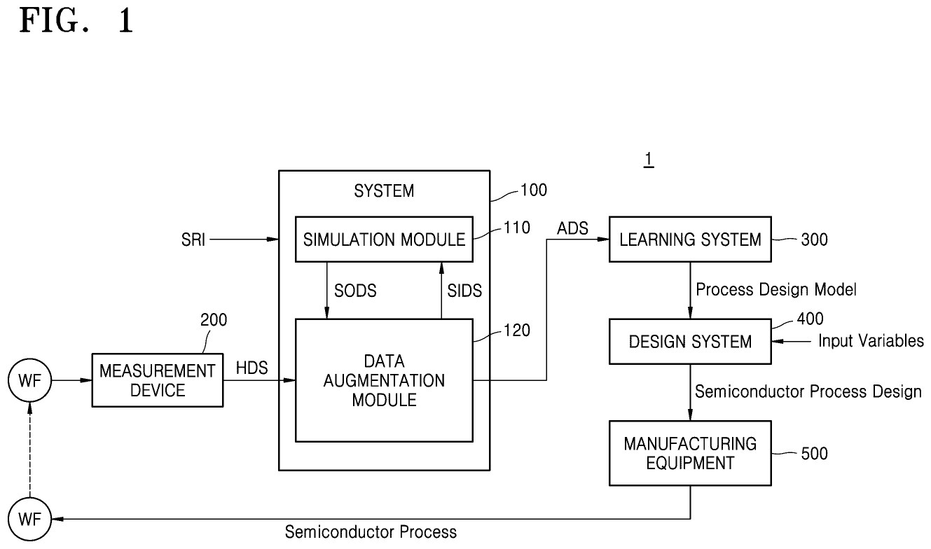

FIG. 1 is a block diagram of a system 1 which includes a system 100 according to some example embodiments.

Referring to FIG. 1, the system 100 may include a simulation module 110 and a data augmentation module 120. The drawing illustrates that the simulation module 110 is inside the system 100, but the simulation module 110 may also be arranged outside the system 100. The simulation module 110 and the data augmentation module 120 may be implemented as hardware or software. In some example embodiments, the system 100 may include a computing system, such as a personal computer, a mobile phone, and a server, may also include a module, in which a plurality of processing cores and memories are mounted on a substrate as independent packages, and may also include a system-on-chip (SoC), in which a plurality of processing cores and memories are embedded in one chip.

The system 100 may include a system configured to augment data received from the outside (e.g., external to system 100). For example, the system 100 may include a system which augments training data for integrated circuit modeling. In another example, the system 100 may include a system which augments training data for semiconductor process simulation. The semiconductor simulation may include a technology computer aided design (TCAD) simulation.

The system 100 may augment a data set related to a recipe for a semiconductor process. The data set related to the recipe for the semiconductor process may include values respectively corresponding to input variables and values respectively corresponding to output variables. The data set may include a plurality of recipe cases.

In some example embodiments, a data set related to a recipe for a semiconductor process may mean a data set of recipes respectively corresponding to various processes performed on a wafer (WF) during the production of a semiconductor product, which may be referred to interchangeably as a semiconductor device (for example, a system semiconductor or a memory semiconductor, such as dynamic random access memory (DRAM), NAND flash memory, and flash memory having a V-NAND (Vertical-NAND) structure). For example, a data set may mean a data set corresponding to a recipe for a high aspect ratio (HAR) etching process, one of the processes performed to form a channel hole. For example, the data set may include a data set corresponding to a recipe for a semiconductor pattern, a data set corresponding to a recipe for inter-cell spacing, a data set corresponding to a thin film thickness control recipe, or a data set corresponding to a process recipe for forming aspect ratio etching. Hereinafter, a recipe for an HAR etching process is described as an example. The HAR etching process may be used as an example, and is not limited thereto. The input variable of the data set may be a variable indicating recipe information, that is, an injection amount of the gases, used in the HAR etching process. In the HAR etching process, because the process may be performed by using several types of gases, the input variable may include injection amount information about at least one type of gas. The output variable of the data set may mean a critical dimension (CD) value corresponding to the diameter of a channel hole formed in the wafer by using the HAR etching process. Hereinafter, a diameter value of the channel hole formed in the wafer may be referred to as a CD value.

Hereinafter, data, of the data sets related to the recipe for the semiconductor process, that is collected by measuring the wafer after performing the real semiconductor process, may be referred to as measurement data or a measurement data set. The measurement data set may be differently referred to as a hardware data set, a real data set, or an experiment data set.

Hereinafter, an input data set, of data sets related to a recipe for a semiconductor process, for performing a simulation, may be referred to as a simulation input data set. In addition, the data set output as a result of performing a simulation may be referred to as a simulation output data set.

Hereinafter, a data set, in which noise of measurement data set is reflected to the simulation output data set by synthesizing the measurement data set and the simulation output data set, may be referred to as a noise simulation data set.

The system 100 may obtain simulation recipe information SRI from the outside. The simulation recipe information SRI may be a value input from the outside (e.g., external to the system 100) by a user (e.g., based on user interaction with an interface of the system 100, such as a keyboard, a mouse, or the like). The simulation recipe information SRI may include information required for simulating a semiconductor process and information for sampling simulation data. For example, the simulation recipe information SRI may include information about input variables, information about output variables, information about sampling ranges, information about sampling methods, and information about the number of sample values.

In some example embodiments, the simulation recipe information SRI may include information about the input variables and output variables, which is information required for simulating a process performed in the production process of a semiconductor product. For example, the information about the input variable may include information indicating that the input values corresponding to the input variable are the types of gases injected during the HAR etching process. For example, the information about the output variable may include information indicating that the output values corresponding to the output variable are the CD values of channel holes generated on a wafer as a result of the HAR etching process.

In some example embodiments, the simulation recipe information SRI may include information about (e.g., “associated with”) the sampling range, the sampling method, and the number (e.g., “quantity”) of sample values, which are required for sampling the values included in the simulation data set. Information about the sampling range may include information indicating a range of sampling values. Information about the sampling method may include information indicating how the sampling is to be performed. For example, the sampling method of input variables may include at least one of a Monte Carlo (MC) sampling method, a Latin hypercube (LHS) sampling method, or a quasi-MC (QMC) sampling method. Information about the number of sample values may include a value input according to a user's need or a value previously input to the system 100.

The system 100 may generate the simulation input data set SIDS based on information included in the simulation recipe information SRI. In FIG. 1, the simulation input data set SIDS is illustrated to be generated by the system 100 based on the simulation recipe information SRI, but the system 100 may obtain the simulation input data set SIDS separately from the outside.

The simulation input data set SIDS may include at least one simulation input case. Each simulation input case may include the input values corresponding to the simulation input variable. The simulation input case may mean a TCAD experiment.

In some example embodiments, it is assumed that there are two simulation input cases and three simulation input variables. In this case, each simulation input case may include input values for a first input variable, a second input variable, and a third input variable. For example, a first simulation input case may include a first input value corresponding to the first input variable, a second input value corresponding to the second input variable, and a third input value corresponding to the third input variable. A second simulation input case may include a fourth input value corresponding to the first input variable, a fifth input value corresponding to the second input variable, and a sixth input value corresponding to the third input variable.

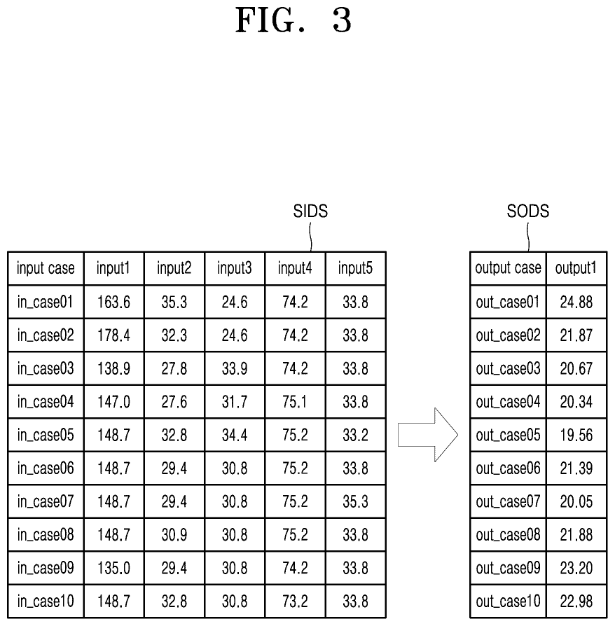

In some example embodiments, the input variable of each simulation input case may include a variable indicating how much gases used in the HAR etching process have been injected. Accordingly, the first through sixth input values may mean injection amounts of gases used in the HAR etching process. Detailed descriptions of the simulation input data set SIDS are given below with reference to FIG. 3.

The simulation module 110 may obtain the simulation input data set SIDS from the data augmentation module 120 or from the outside. The simulation module 110 may perform a simulation for each input case included in the simulation input data set SIDS, and generate a simulation output data set SODS.

In some example embodiments, the simulation performed on the simulation input data set SIDS may include the TCAD simulation.

The simulation output data set SODS may include at least one simulation output case. The simulation output cases may include the output values respectively corresponding to the output variables. Each of the simulation output cases included in the simulation output data set SODS may correspond to the simulation input cases included in the simulation input data set SIDS. For example, the simulation result value according to the input value of the first simulation input case may include an output value of a first simulation output case. The simulation output case may mean the TCAD experiment.

In some example embodiments, it is assumed that there are two simulation input cases of the simulation input data set SIDS corresponding to the simulation output data set SODS. In this case, there may also be two simulation output cases. In this case, it is assumed that there is one output variable of the simulation output case. In other words, each simulation output case may include an output value corresponding to a first output variable. In other words, the first simulation output case may include a first output value corresponding to the first output variable. A second simulation output case may include a second output value corresponding to the second output variable.

In some example embodiments, the output variable may include a variable indicating the CD value of the channel hole formed in the wafer according to the injection amounts of gases used in the HAR etching process. Detailed descriptions of the simulation output data set SODS are given below with reference to FIG. 3.

The data augmentation module 120 may generate and output a synthesized data set ADS based on the measurement data set HDS, the simulation input data set SIDS, and the simulation output data set SODS.

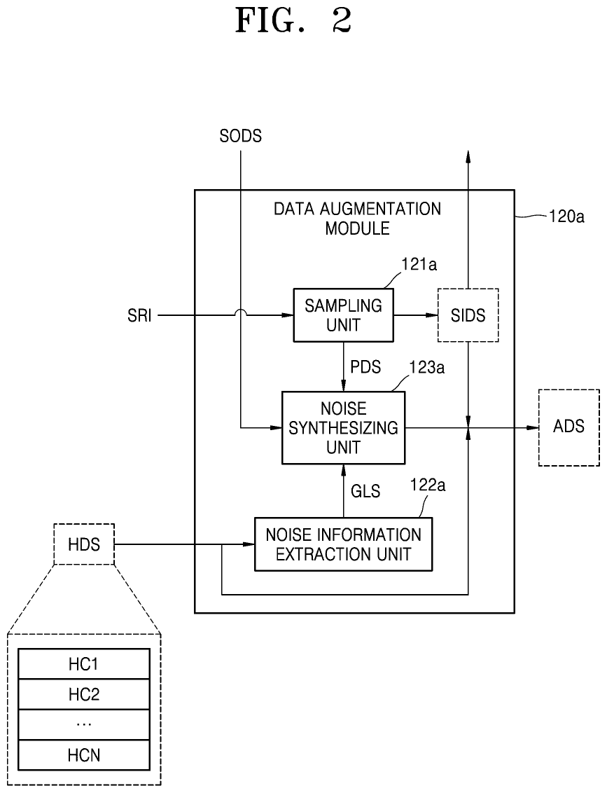

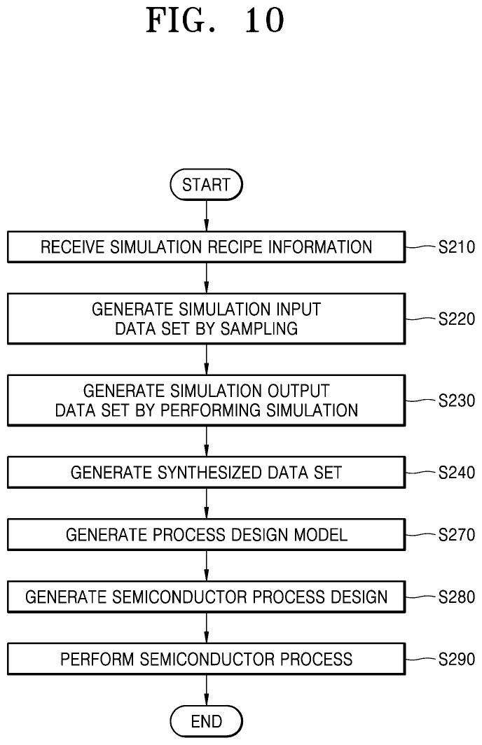

The data augmentation module 120 may extract noise information from the measurement data set HDS. The data augmentation module 120 may generate distribution information about each simulation output case, by synthesizing the extracted noise information with each simulation output case included in the simulation output data set SODS. The data augmentation module 120 may sample output values according to distribution information about the simulation output cases. The data augmentation module 120 may generate the synthesized data set ADS by combining the measurement data set HDS, the simulation input data set SIDS, and the noise simulation data set. Detailed descriptions of the data augmentation module 120 are given below with reference to FIGS. 2 and 10.

The system 100 may obtain the actual measurement data set HDS from a measurement device 200. The measurement device 200 may include an apparatus for measuring a structure of a semiconductor device. For example, the measurement device 200 may generate the measurement data set HDS by measuring the wafer WF, on which the semiconductor process has been performed. In some example embodiments, the measurement device 200 may include a camera device configured to generate (e.g., capture) an image of at least a portion of the wafer WF.

In some example embodiments, the measurement data set HDS may include a plurality of measurement cases. Each of the plurality of measurement cases may be referred to as data including a recipe used in the HAR etching process and a result value (or an output value) according to the corresponding recipe. For example, each of the plurality of measurement cases may include an injection amount of each gas used in the HAR etching process and CD values of the channel holes present on the wafer (WF) corresponding thereto. In this case, the CD values may form a statistically continuous distribution. In other words, the CD values may form a continuous probability distribution, and accordingly, may be expressed by a probability density function (pdf).

In some example embodiments, in the drawing, the system 100 is illustrated to obtain the measurement data set HDS from the measurement device 200, but the measurement data set HDS may include data stored in a separate storage medium, and may be input to the system 100 via such a storage medium.

The system 100 may augment data, by generating a synthesized data set ADS in several ways. For example, the system 100 may augment data related to the semiconductor process by operating in a first mode, a second mode, or a third mode.

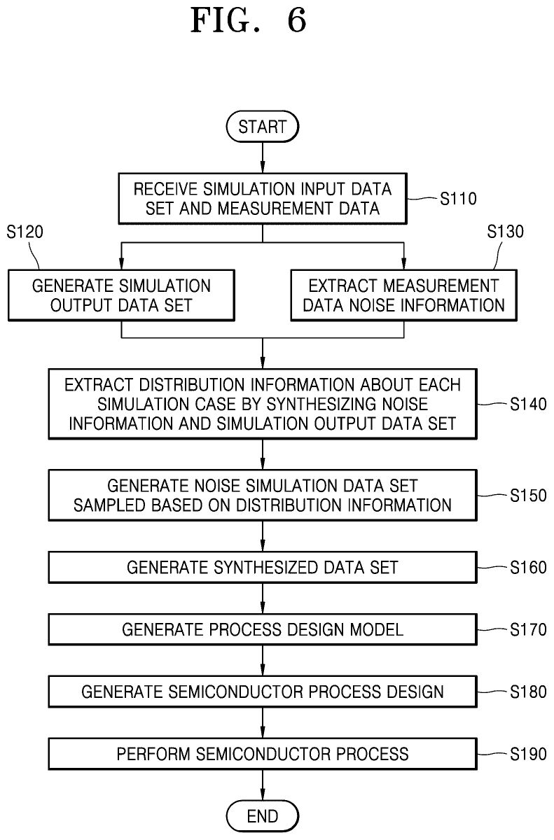

In some example embodiments, when the system 100 operates in the first mode, the system 100 may generate the synthesized data set ADS based on the measurement data set HDS, the simulation input data set SIDS, and the simulation output data set SODS, by using the data augmentation module 120. The operation of the system 100 in the first mode is described below with reference to FIGS. 2 and 6.

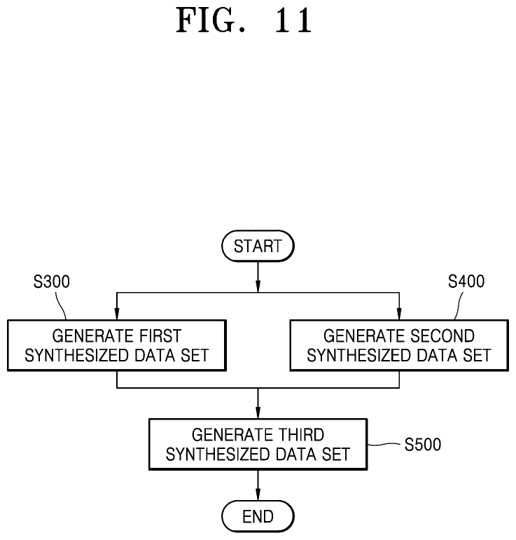

In some example embodiments, when the system 100 operates in the second mode, the system 100 may sample the simulation input data set SIDS by using the simulation recipe information SRI, and generate the simulation output data set SODS by performing a simulation using the simulation input data set SIDS. The system 100 may generate a synthesized data set by synthesizing the simulation input data set SIDS and the simulation output data set SODS. The operation of the system 100 in the second mode is described below with reference to FIGS. 10 and 11.

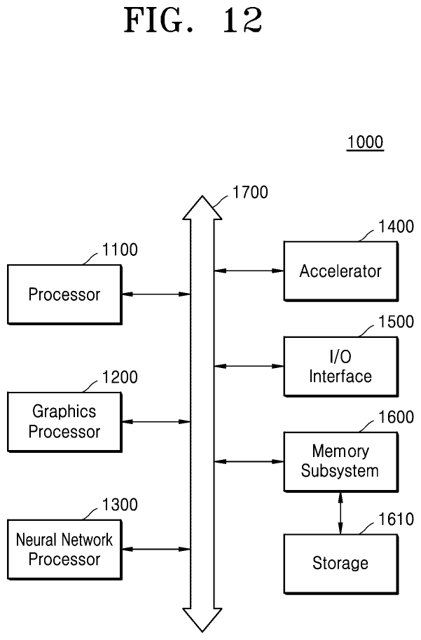

In some example embodiments, when the system 100 operates in the third mode, the system 100 may generate a first synthesized data set in the first mode, a second synthesized data set in the second mode, and then combine the first synthesized data set with the second synthesized data set to generate a third synthesized data set. The operation of the system 100 in the third mode is described below with reference to FIG. 12.

A program for performing a method of augmenting data according to some example embodiments may be stored in a computer-readable non-transitory storage medium. The term “computer-readable medium” may include all types of media accessible by a computer, such as read-only memory (ROM), random access memory (RAM), a hard disk drive, a compact disk (CD), a digital video disk (DVD), or some other type of memory. The term “non-transitory” computer-readable medium may include a medium excluding wired, wireless, optical, or other communication links transmitting temporary electrical or other signals, and permanently storing data, and a medium storing data and rewriting data later, such as rewritable optical disks or erasable memory devices. The program may be executed by a processor (e.g., a central processing unit, or CPU) to cause the processor to perform the method of augmenting data according to some example embodiments.

In some example embodiments, the synthesized data set ADS may be provided as training data to a learning system 300 that is configured to learn (e.g., implement machine learning) to generate one or more machine learning models, also referred to herein as one or more artificial intelligence models, one or more design models, one or more process design models, or the like, that are configured to perform a semiconductor process simulation, semiconductor product modeling (e.g., integrated circuit modeling, etc.), semiconductor process modeling to model a semiconductor product design based on process recipe information, or the like. Accordingly, in some example embodiments, a method may include training one or more machine learning models (“process design models”) with the synthesized data set ADS. Such training may include applying data of the simulation input data set, input values of the measurement data set, or the like as input values to the one or more machine learning models and applying data of the noise simulation data set, output values of the measurement data set, or the like as output values to the one or more machine learning models.

In some example embodiments, a process design model (machine learning model) generated by the learning system 300 based on using the synthesized data set ADS as training data may utilize, as an input (e.g., one or more input variables), semiconductor process recipe information that may be used as operation parameters to control manufacturing equipment to perform a semiconductor process. Such process recipe information may include, for example, amounts of various certain types of gases to be injected into a chamber holding a wafer WF to at least partially implement an HAR etching process. The process design model may indicate, as an output, one or more properties of a design for a semiconductor product to be at least partially manufactured according to a semiconductor process (e.g., channel hole CD values for channel holes of the semiconductor product formed via the semiconductor process, inter-cell spacing of a semiconductor pattern of the semiconductor product formed via the semiconductor process, thin film thickness of at least a portion of the semiconductor product formed via the semiconductor process, or the like).

In some example embodiments, a process design model (machine learning model) generated by the learning system 300 based on using the synthesized data set ADS as training data may utilize, as an input (e.g., one or more input variables), one or more properties of a design for a semiconductor product to be at least partially manufactured according to a semiconductor process (e.g., channel hole CD values for channel holes of the semiconductor product formed via the semiconductor process, inter-cell spacing of a semiconductor pattern of the semiconductor product formed via the semiconductor process, thin film thickness of at least a portion of the semiconductor product formed via the semiconductor process, or the like). The process design model may indicate, as an output, semiconductor process recipe information that may be used as operation parameters to control manufacturing equipment to perform the semiconductor process to at least partially manufacture a semiconductor product having the one or more properties of the design for a semiconductor product. Such process recipe information may include, for example, amounts of various certain types of gases to be injected into a chamber holding a wafer WF to at least partially implement an HAR etching process.

The learning system 300 may include a hardware structure specialized for processing (e.g., configured to implement, generate, create, etc.) an artificial intelligence model (e.g., as a machine learning model, process design model, etc.). Artificial intelligence models may be created through machine learning, for example using a learning algorithm. For example, the learning system 300 may apply a learning algorithm to the synthesized data set that is provided by the system 100 to create an output algorithm, for example an artificial intelligence model, a “process design model,” or the like, that 1) determines semiconductor product design information (e.g., CD value of channel holes, inter-cell spacing, thin film thickness, etc. based on one or more input variables including semiconductor process recipe information for a semiconductor process (e.g., amounts of various certain gases injected in an HAR etching process) and/or 2) determines semiconductor process recipe information for a semiconductor process (e.g., amounts of various certain gases injected in an HAR etching process) based on one or more input variables including semiconductor product design information (e.g., CD value of channel holes, inter-cell spacing, thin film thickness, etc. The learning algorithm may include, for example, supervised learning, unsupervised learning, semi-supervised learning, or reinforcement learning, but is not limited to the above examples. The artificial intelligence model may include a plurality of artificial neural network layers.

As an example, the learning system 300 may implement an artificial neural network that is trained on training data (e.g., synthesized data set ADS) generated by the system 100 by, for example, a supervised, unsupervised, and/or reinforcement learning model, and wherein the learning system 300 may process a feature vector to provide output based upon the training.

Artificial neural networks may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but are not limited to the above examples. The artificial intelligence model may include, in addition or alternatively, software structures in addition to hardware structures. Alternatively or additionally, the learning system 300 may implement other forms of artificial intelligence and/or machine learning based on the learning data, such as, for example, linear and/or logistic regression, statistical clustering, Bayesian classification, decision trees, dimensionality reduction such as principal component analysis, and expert systems; and/or combinations thereof, including ensembles such as random forests. Herein, an artificial neural network may have any structure that is trainable, e.g., with learning data that is used as training data.

The learning system 300 may perform learning (e.g., learn content, generate learned content, etc.) using data (e.g., learning data, synthesized data set ADS) generated by the system 100 through the artificial neural network. Such learning (e.g., the learned content) may include an algorithm that utilizes one or more input variables (e.g., semiconductor process recipe information and/or semiconductor product design information) as an input and has an output (e.g., semiconductor product design information and/or semiconductor process recipe information) that may be used to generate 1) a semiconductor product design and/or 2) semiconductor process recipe information which may be applied to control manufacturing equipment to perform a semiconductor process to at least partially manufacture a semiconductor device having the semiconductor product design.

The learning system 300 may provide the generated process design model, which may include the algorithm, to the design system 400, where the design model and/or the algorithm may be applied by the design system 400 to utilize one or more input variables in order to generate an output corresponding to a semiconductor process design.

For example, in example embodiments where the process design model generated at system 300 determines semiconductor product design information as an output based on utilizing semiconductor process recipe information as an input, the design system 400 may apply the process design model to input variables that include semiconductor process recipe information to determine semiconductor product design information to at least partially develop a semiconductor process design. Such a design information determination might be iteratively performed (e.g., where the semiconductor recipe information such as an amount of certain gases used in an HAR etching process may be iteratively adjusted to adjust the semiconductor product design information, such as CD values) until the semiconductor product design information at least meets one or more threshold values.

In another example, in example embodiments where the process design model generated at system 300 determines semiconductor process recipe information (e.g., amounts of certain gases to inject in an HAR etching process) as an output based on utilizing semiconductor product design information (e.g., CD values) as an input, the design system 400 may apply the process design model to input variables that include semiconductor product design information to determine semiconductor process recipe information to at least partially develop a semiconductor process design.

The semiconductor process design and/or information associated therewith may be provided to one or more articles of manufacturing equipment 500 to cause the manufacturing equipment to perform one or more semiconductor processes on a wafer WF to at least partially manufacture a semiconductor device according to the semiconductor process design.

The manufacturing equipment 500 may include equipment configured to perform one or more semiconductor processes (e.g., on a wafer WF) according to the semiconductor process design (e.g., based on semiconductor process recipe information and/or semiconductor product design information) received from the design system 400. For example, the manufacturing equipment 500 may include equipment configured to perform one or more semiconductor processes on a wafer WF during the production (e.g., manufacture) of a semiconductor product (for example, a system semiconductor or a memory semiconductor, such as dynamic random access memory (DRAM), NAND flash memory, and flash memory having a V-NAND (Vertical-NAND) structure). For example, the manufacturing equipment 500 may include equipment configured to perform a high aspect ratio (HAR) etching process, for example to form a channel hole in a wafer WF. For example, the manufacturing equipment 500 may include equipment configured to form a semiconductor device having a particular semiconductor pattern, a particular channel hole CD value, a particular inter-cell spacing, a particular thin film thickness, a particular aspect ratio etching, or the like. The manufacturing equipment 500 may include equipment configured to inject various gases onto the wafer WF, for example as part of an HAR etching process.

While system 100, learning system 300, design system 400, measurement device 200, and manufacturing equipment 500 are illustrated in FIG. 1 as separate elements, it will be understood that two or more of system 100, learning system 300, design system 400, measurement device 200, and manufacturing equipment 500 may be included in and/or implemented by a single hardware device, for example a system 1000 as shown in FIG. 12, one or more instances of processing circuitry such as hardware including logic circuits; a hardware/software combination such as a processor executing software; or any combination thereof, or the like. It will further be understood that one or more of learning system 300, design system 400, or manufacturing equipment 500 may be omitted from system 1.

Based on the learning system 300 using the synthesized data set ADS as a learning data input to generate the process design model, where the synthesized data set ADS has an expanded amount of measurement data that also reflects noise and uncertainty of hardware measurement data characterized in measurement data HDS, the process design model generated by the learning system 300 may have improved accuracy and/or reliability in being able to determine semiconductor process recipe information that may, when used by manufacturing equipment 500 to perform a semiconductor process, cause the semiconductor process performed by the manufacturing equipment 500 to manufacture semiconductor products that more reliably have properties that conform to the desired semiconductor product design information (e.g., CD values of channel holes of a semiconductor product that is at least partially manufactured using an HAR etching process).

As a result, the yield of acceptable (e.g., sufficiently defect-free) semiconductor products manufactured based on information generated using a process design model that is itself generated using augmented training data that includes the synthesized data set ADS having a greater amount of synthesized measurement data that reflects the noise and uncertainty associated with the initial measurement data (HDS) may be improved due to the increased amount of input measurement data represented by the synthesized data set ADS to generate the design model in comparison to the measurement data set HDS.

As a further result, semiconductor product manufacturing efficiency and performance may be improved, and manufactured semiconductor product reliability and performance may be improved, based on the generation of the synthesized data set ADS as augmented training data that may be used as training data for a design model used to generate process recipe information to perform semiconductor processes, as described herein. In particular, the manufacture of semiconductor products, and the semiconductor products themselves based on using a process design model that is trained using training data may be improved based on the training data being augmented using measurement data HDS where the augmentation includes 1) obtaining a simulation input data set and a measurement data set, 2) obtaining a simulation output data set generated based on performing a simulation based on the simulation input data set, 3) extracting reference noise information associated with the measurement data set from the measurement data set, 4) extracting distribution information associated with each simulation case included in the simulation output data set based on synthesizing the reference noise information and the simulation output data set, 5) generating a noise simulation data set based on sampling data based on the distribution information, and 6) generating the synthesized data set based on synthesizing the simulation input data set, the noise simulation data set, and the measurement data set.

According to a method according to some example embodiments of the present disclosure, the system 100 may augment data by generating the synthesized data set ADS reflecting uncertainty generated in a measurement data set HDS. Through this, it is possible to augment a data set in which only a small number of cases exist, such as a bad data set. The augmented data set can be used as data to improve the performance of machine learning models such as poor prediction models. Since the size (e.g., number of cases) of the measurement data set HDS may be limited, the measurement data set HDS alone may be insufficient to improve the performance of the machine learning model. However, if the measurement data set HDS is augmented based on some example embodiments of the present disclosure, the synthesized data set ADS can be created. The synthesized data set ADS may be an augmented data set considering stochastic elements such as noise existing in the measurement data set HDS. With the synthesized data set ADS, the performance of machine learning models (e.g., poor prediction models) can be improved.

In addition, according to the method according to some example embodiments of the present disclosure, when the user does not have the measurement data set HDS, the data can be augmented by creating the synthesized data set ADS that reflects uncertainties (e.g., equipment errors). In other words, even when the measurement data set HDS does not exist, it is possible to create the synthesized data set ADS having similar probabilistic characteristics to the measurement data set HDS, and the user can use the actual semiconductor product in the production process. It is possible to simulate variability such as errors that may occur.

FIG. 2 is a block diagram of a data augmentation module 120a according to some example embodiments. The diagram illustrates that the system 100 operates in a first mode to generate synthesized data. FIG. 2 may be described with reference to FIG. 1, and duplicate descriptions may be omitted.

The data augmentation module 120a of FIG. 2 may correspond to the data augmentation module 120 in FIG. 1. The data augmentation module 120a may include a sampling unit 121a, a noise information extraction unit 122a, and a noise synthesizing unit 123a. In addition, the sampling unit 121a, the noise information extraction unit 122a, and the noise synthesizing unit 123a may be implemented in hardware or software.

The sampling unit 121a may obtain the simulation recipe information SRI from the outside. The sampling unit 121a may sample the simulation input data set SIDS based on the information included in the simulation recipe information SRI. In this case, the sampling method of the input variable may include at least one of the MC sampling method, the LHS method, or the QMC method. The sampling method may be selected by a user, and may be selected by information previously input to the system 100.

In some example embodiments, it is assumed that the input variable includes only the first input variable, and means an injection amount of H₂ gas injected in the HAR etching process. It is assumed that the sampling range includes a value between 100 and 200. It is assumed that the number of sample values is 100. It is assumed that the LHS method is used for sampling. In this case, the sampling unit 121a may generate 100 arbitrary values in the range of 100 to 200 by using the LHS method. The generated 100 values may include values indicating an injection amount of H₂ gas. Because there are 100 arbitrary values for the first input variable, each value thereof may correspond to one simulation input case. In other words, the simulation input data set SIDS may include 100 simulation input cases.

The data augmentation module 120a may output the simulation input data set SIDS, and obtain the simulation output data set SODS generated by the simulation module 110 in FIG. 1 via the noise synthesizing unit 123a.

The noise information extraction unit 122a may extract noise information from the measurement data set HDS. The measurement data set HDS may include N (N≥1) of measurement cases, that is, first through N^{th} measurement cases HC1 through HCN. Hereinafter, the measurement data set HDS may include two measurement cases, that is, the first measurement case HC1 and the second measurement case HC2. Although this may be an example of including two measurement cases, more or less measurement cases may be included. The measurement data cases may be generated by measuring a real wafer rather than the simulation data. Output values of the measurement data case may include noise.

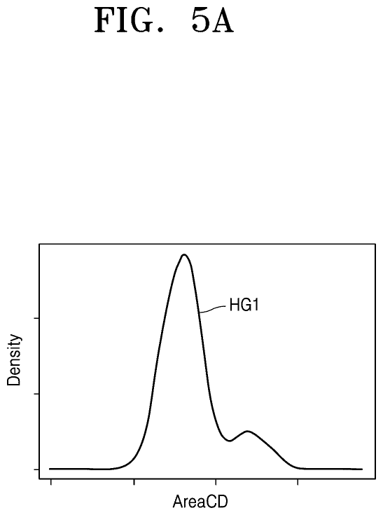

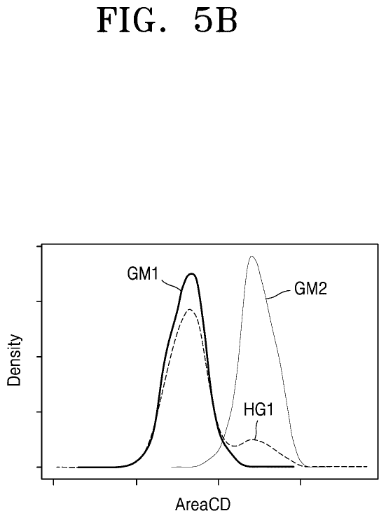

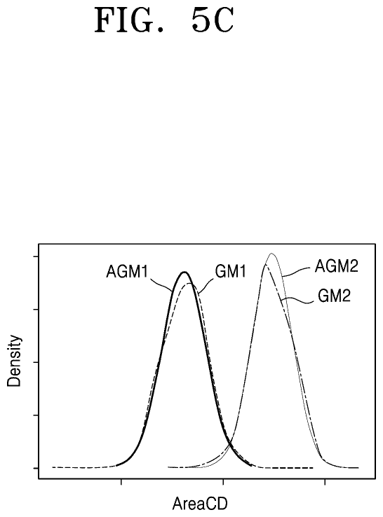

The noise information extraction unit 122a may output, in a graph form, the distribution of each measurement case included in the measurement data set HDS. This issue is described below with reference to FIG. 5A. A user may determine the number of Gaussian graphs to describe the corresponding measurement case graph by using the distribution graph of each measurement case, and thus the number of Gaussian models constituting the Gaussian mixing model (GMM) may be determined. Hereinafter, the Gaussian mixture model may be referred to as the GMM. Information related to the number of Gaussian models may include a value previously input into the system 100, and may be input by a user during an operation of the system 100. Hereinafter, it is assumed that each of the measurement cases is described by using two Gaussian models. The noise information extraction unit 122a may generate the GMM corresponding to each measurement case by using an expectation-maximization (EM) algorithm, and each GMM may include two Gaussian models. The noise information extraction unit 122a may extract noise information corresponding to each GMM.

In some example embodiments, a first GMM corresponding to the first measurement case HC1 may include a first Gaussian model and a second Gaussian model. A second GMM corresponding to the second measurement case HC2 may include a third Gaussian model and a fourth Gaussian model.

The noise information extraction unit 122a may extract a gamma value γ_{i,j} corresponding to each Gaussian model by using Formula 1 below. Hereinafter, the gamma value γ_{i,j} may mean a ratio of an average value μ_{i,j} of each Gaussian model over an average value μ̅ⱼ of the output values included in each measurement case. N_{GM} may mean the number of Gaussian models included in the GMM. In other words, according to the assumption with respect to FIG. 2, because the GMM may be modeled by using two Gaussian models, N_{GM} may be 2. N_{HC} may mean the number of measurement cases included in the measurement data set HDS. In other words, according to the assumption with respect to FIG. 2, the measurement case included in the measurement data set HDS may include the first measurement case HC1 and the second measurement case HC2, and thus, N_{HC} may be 2.

$${γ}_{i , j} = \frac{{μ}_{i , j}}{{\overline{μ}}_{j}} , ∀ i \leq {N}_{GM} , ∀ j \leq {N}_{H C} \qquad [ Formula 1 ]$$

The noise information extraction unit 122a may extract a lambda value λ_{i,j} corresponding to each Gaussian model by using Formula 2 below. Hereinafter, the lambda value λ_{i,j} may mean a ratio of the average value μ_{i,j} of each Gaussian model over a standard deviation value σ_{i,j} of each Gaussian model.

$${λ}_{i , j} = \frac{{μ}_{i , j}}{{σ}_{i , j}} , ∀ i \leq {N}_{GM} , ∀ j \leq {N}_{H C} \qquad [ Formula 2 ]$$

In some example embodiments, the noise information extraction unit 122a may extract, according to Formula 1 and Formula 2, a first gamma value γ_{1,1} and a first lambda value A, corresponding to the first Gaussian model, a second gamma value γ_{2,1} and a second lambda value λ_{2,1} corresponding to the second Gaussian model, a third gamma value γ_{1,2} and a third lambda λ_{1,2} corresponding to the third Gaussian model, and a fourth gamma value γ_{2,2} and a fourth lambda value λ_{2,2} corresponding to the fourth Gaussian model.

The noise information corresponding to the first GMM may include first noise information. The first noise information may include the first gamma value γ_{1,1}, the first lambda value λ_{1,1}, the second gamma value γ_{2,1} and the second lambda value λ_{2,1}.

The noise information corresponding to the second GMM may include second noise information. The second noise information may include the third gamma value γ_{1,2}, the third lambda value λ_{1,2}, the fourth gamma value γ_{2,2}, and the fourth lambda value λ_{2,2}.

The noise information extraction unit 122a may extract average noise information by calculating the average value of gamma values extracted from the measurement data set HDS and the average value of lambda values. In this case, because the GMM corresponding to each measurement case includes two Gaussian models, the average noise information may include a first average gamma value \hat{γ}₁, a first average lambda value \hat{λ}₁, a second average gamma value \hat{γ}₂, and a second average lambda value \hat{λ}₂.

For example, the first average gamma value \hat{γ}₁ may be an average of the first gamma value γ_{1,1}, which is the gamma value of the first Gaussian model of the first GMM, and the third gamma value γ_{1,2}, which is the gamma value \hat{γ}₁ of the third Gaussian model of the second GMM.

For example, the first average lambda value \hat{λ}₁ may be an average of the first lambda value λ_{1,1}, which is the lambda value of the first Gaussian model of the first GMM, and the third lambda value λ_{1,2}, which is the lambda value of the third Gaussian model of the second GMM.

For example, the second average gamma value \hat{γ}₂ may be an average of the second gamma value γ_{2,1}, which is the gamma value of the second Gaussian model of the first GMM, and the fourth gamma value γ_{2,2}, which is the gamma value of the fourth Gaussian model of the second GMM γ₂.

For example, the second average lambda value \hat{λ}₂ may be an average of the second lambda value λ_{2,1}, which is the lambda value of the second Gaussian model of the first GMM, and the fourth lambda value λ_{2,2}, which is the lambda value of the fourth Gaussian model of the second GMM.

The noise information extraction unit 122a may select the average noise information or noise information corresponding to any one GMM of the noise information corresponding to each GMM. The noise information extraction unit 122a may set the selected noise information as reference noise information GLS.

In some example embodiments, the noise information extraction unit 122a may select any one of the first noise information, second noise information, or the average noise information, and set the selected one as the reference noise information GLS.

In some example embodiments, the reference noise information GLS may be determined by a user's selection. For example, when the user does not make the selection, the average noise information may be set as the reference noise information GLS. For example, the first noise information may be set as the reference noise information GLS by the user's selection or by a pre-input system setting. For example, any value input by the user may be set as the reference noise information GLS. Hereinafter, it is assumed that the average noise information is set as the reference noise information GLS.

The noise information extraction unit 122a may transmit the reference noise information GLS to the noise synthesizing unit 123a.

The noise synthesizing unit 123a may obtain the simulation output data set SODS from the simulation module 110. Simulation distribution information corresponding to each simulation output case may be generated based on the output value corresponding to each simulation output case included in the simulation output data set SODS and the reference noise information GLS. In other words, unlike each measurement case included in the measurement data set HDS that has a continuous probability distribution, each simulation output case in the simulation output data set SODS may have a fixed output value corresponding to the simulation input case. However, by synthesizing the simulation output data set SODS and the reference noise information GLS by the noise synthesizing unit 123a, probability distribution information corresponding to each simulation output case of the simulation output data set SODS may be generated. In other words, for each simulation output case, an average value m_{i,k} and a standard deviation value s_{i,k} corresponding thereto may be derived.

In the operation of the noise synthesizing unit 123a, distribution information corresponding to each simulation output case may be extracted by using Formula 3 and Formula 4 below. The distribution information of each simulation output case may include the average value m_{i,k} and the standard deviation value s_{i,k}. The noise synthesizing unit 123a may calculate, according to Formula 3 below, gamma values included in the reference noise information GLS and the output values ovₖ of each simulation output case included in the simulation output data set SODS, and may extract the average value m_{i,k} corresponding to the simulation output case. In this case, N_{SC} may mean the number of each simulation output case included in the simulation output data set SODS. N_{GM} may mean the number of Gaussian models corresponding to the reference noise information GLS. As described above, according to the assumption with respect to FIG. 2, N_{GM} may be 2.

$${m}_{i , k} = {\hat{γ}}_{i} \times o {v}_{k} , ∀ i \leq {N}_{G M} , ∀ k \leq {N}_{S C} \qquad [ Formula 3 ]$$

The noise synthesizing unit 123a may calculate, according to Formula 4 below, the lambda values included in the reference noise information GLS and the average value m_{i,k} of the simulation output case calculated according to Formula 3, to extract the standard deviation value s_{i,k} corresponding to the simulation output case.

$${s}_{i , k} = \frac{{m}_{i , k}}{{\hat{λ}}_{i}} , ∀ i \leq {N}_{GM} , ∀ k \leq {N}_{S C} \qquad [ Formula 4 ]$$

In some example embodiments, it is assumed that the simulation input data set SIDS has three simulation input cases. In this case, the simulation output data set SODS may have three simulation output cases corresponding to the simulation input data set SIDS, and accordingly, N_{SC} may be 3. In other words, the simulation output data set SODS may include the first simulation output case, the second simulation output case, and a third simulation output case. In this case, the first simulation output case may include a first simulation output value ov₁. The second simulation output case may include a second simulation output value ov₂. The third simulation output case may include a third simulation output value ov₃.

When the reference noise information GLS is synthesized with the first simulation output case by the noise synthesizing unit 123a, first simulation distribution information corresponding to the first simulation output case may be generated. Because the reference noise information GLS includes noise information corresponding to two Gaussian models, the first simulation distribution information may also have an average value and a standard deviation value corresponding to two Gaussian models. In other words, the first simulation distribution information may include a first simulation average value m_{1,1} and a first simulation standard deviation value s_{1,1} corresponding to the first Gaussian model, and may include a second simulation average value m_{2,1} and a second simulation standard deviation value s_{2,1} corresponding to the second Gaussian model.

Similarly, second simulation distribution information corresponding to the second simulation output case may be generated. The second simulation distribution information may include a third simulation average value m_{1,2} and a third simulation standard deviation value s_{1,2} corresponding to the first Gaussian model, and may include a fourth simulation average value m_{2,2} and a fourth simulation standard deviation value s_{2,2} corresponding to the second Gaussian model.

In addition, third simulation distribution information corresponding to the third simulation output case may be generated. The third simulation distribution information may include a fifth simulation average value m_{1,3} and a fifth simulation standard deviation value s_{1,3} corresponding to the first Gaussian model, and may include a sixth simulation average value m_{2,3} and a sixth simulation standard deviation value s_{2,3} corresponding to the second Gaussian model.

The noise synthesizing unit 123a may obtain a sampling data set PDS from the sampling unit 121a. In some example embodiments, the sampling unit 121a may generate the sampling data set PDS. The sampling data set PDS may include sample values sampled by using the QMC sampling method based on a sobol sequence. The sample values included in the sampling data set may form a uniform distribution.

The noise synthesizing unit 123a may generate the noise simulation data set, in which noise has been reflected by inversely transforming the sample values included in the sampling data set PDS according to the simulation distribution information. The noise simulation data set may include at least one noise simulation case. The noise simulation data set may mean a data set, in which the noise information extracted from the measurement data set HDS and the simulation output data set SODS is synthesized. The noise simulation data set may include at least one noise simulation case. The number (e.g., “quantity”) of noise simulation cases included in a noise simulation set may be the same as the number of simulation output cases included in the simulation output data set SODS. Hereinafter, because the number of simulation output cases is assumed to be three as described above, it is assumed that the number of noise simulation cases included in the noise simulation data set is also three.

In some example embodiments, the noise synthesizing unit 123a may perform an inverse transform so that the sample values included in the sampling data set PDS match the first simulation distribution information. In this case, because each piece of simulation distribution information includes an average value and a standard deviation value for two Gaussian models, the inverse transform may be performed considering the weight for each Gaussian model. The weight for each Gaussian model may include a value input by a user or a value previously input to the system 100. For example, the sampling unit 121a may sample 120 sample values for the sampling data set PDS, according to the QMC method. In this case, it is assumed that the weight of the first Gaussian model is 1 and the weight of the second Gaussian model is 3. In this case, when the noise synthesizing unit 123a performs an inverse transform according to the first simulation distribution information, 30 sample values may perform the inverse transform to match the first simulation average value m_{1,1} and the first simulation standard deviation value s_{1,1}, and 90 sample values may perform the inverse transform to match the second simulation average value m_{2,1} and the second simulation standard deviation value s_{2,1}. The noise synthesizing unit 123a may generate a first noise simulation case, by performing the inverse transform on sample values included in the sampling data set PDS according to the first simulation distribution information.

Similarly, the noise synthesizing unit 123a may perform an inverse transform so that the sample values included in the sampling data set PDS match the second simulation distribution information. For example, 30 sample values may perform the inverse transform to match the third simulation average value m_{1,2} and the third simulation standard deviation value s_{1,2}, and 90 sample values may perform the inverse transform to match the fourth simulation average value m_{2,2} and the fourth simulation standard deviation value s_{2,2}. The noise synthesizing unit 123a may generate a second noise simulation case, by performing the inverse transform on sample values included in the sampling data set PDS according to the second simulation distribution information.

In addition, the noise synthesizing unit 123a may perform the inverse transform so that the sample values included in the sampling data set PDS match the third simulation distribution information. For example, 30 sample values may perform the inverse transform to match the fifth simulation average value m_{1,3} and the fifth simulation standard deviation value s_{1,3}, and 90 sample values may perform the inverse transform to match the sixth simulation average value m_{2,3} and the sixth simulation standard deviation value s_{2,3}. The noise synthesizing unit 123a may generate a third noise simulation case, by performing the inverse transform on sample values included in the sampling data set PDS according to the third simulation distribution information.

The data augmentation module 120a may generate the synthesized data set ADS by synthesizing the simulation input data set SIDS, the measurement data set HDS, and the noise simulation data set. In other words, the system 100 may augment the data by generating a simulation data set with noise reflected therein, based on the measurement data set HDS and the simulation input data set SIDS, and by applying this result to a machine learning model, may improve the yield of the semiconductor process.

In some example embodiments, such application to the machine learning model, for example as part of providing the synthesized data set ADS to the learning system 300 of FIG. 1, may include applying data of the simulation input data set SIDS, input values of the measurement data set HDS, or the like as input values to the machine learning model and applying data of the noise simulation data set, output values of the measurement data set HDS, or the like as output values to the machine learning model, to thereby train the machine learning model to determine output values of semiconductor produce design information (e.g., CD values of the channel holes present on a wafer based on an HAR etching process being performed on the wafer) based on input values of semiconductor process recipe information (an injection amount of each gas used in the HAR etching process).

In some example embodiments, such application to the machine learning model, for example as part of providing the synthesized data set ADS to the learning system 300 of FIG. 1, may include applying data of the noise simulation data set, output values of the measurement data set HDS, or the like as input values to the machine learning model and applying data of the simulation input data set SIDS, input values of the measurement data set HDS, or the like as output values to the machine learning model, to thereby train the machine learning model to determine output values of semiconductor process recipe information (an injection amount of each gas used in the HAR etching process) based on input values of semiconductor product design information (e.g., CD values of the channel holes present on a wafer based on an HAR etching process being performed on the wafer).

FIG. 3 illustrates diagrams of the simulation data set according to some example embodiments. FIG. 3 is a diagram of compositions of the simulation input data set SIDS and the simulation output data set SODS. FIG. 3 may be described with reference to FIGS. 1 and 2, and duplicate descriptions thereof may be omitted.

The simulation input data set SIDS may include a plurality of simulation input cases. In this case, the simulation input case may be referred to as a simulation input experiment. Each simulation input case may include the input value corresponding to at least one simulation input variable.

In some example embodiments, referring to FIG. 3, the simulation input data set SIDS may include first through tenth simulation input cases in_case01 through in_case10. In addition, the simulation input data set SIDS may include information about five input variables. In other words, the five input variables may include information about first through fifth input variables input1 through input5.

In some example embodiments, when the TCAD simulation is performed based on the simulation input data set SIDS, the simulation output data set SODS may be generated.

The simulation output data set SODS may include a plurality of simulation output cases. In this case, the simulation output case may be referred to as a simulation output experiment. The simulation output case may include the output value corresponding to at least one output variable.

In some example embodiments, referring to FIG. 3, the simulation output data set SODS may include first through tenth simulation output cases out_case01 through out_case10. In addition, the simulation output data set SODS may include information about one output variable. In other words, information about the first output variable output1 may be included.

In some example embodiments, each simulation input case of the simulation input data set SIDS may include process recipe information used to produce semiconductor products. For example, each simulation input case may include data corresponding to recipe information used in the HAR etching process, which is one of the processes performed to form a channel hole in a wafer during the production process of the semiconductor products. In this case, for example, the first input variable may mean the injection amount of H₂ gas, the second input variable may mean the injection amount of Cl₂ gas, the third input variable may mean the injection amount of HBr gas, a fourth input variable may mean the injection amount of CH₂F₂ gas, and a fifth input variable may mean the injection amount of NF₃ gas.

In addition, the output value of each simulation output case of the simulation output data set SODS may mean the CD value of the channel hole formed in the semiconductor product when the process is performed for the simulation input case. In other words, the first output variable may mean the CD value of the channel hole.

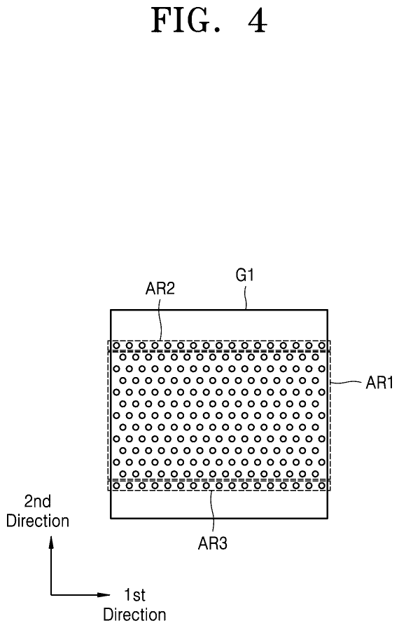

FIG. 4 is a diagram of measurement data according to some example embodiments. FIG. 4 may be described with reference to FIGS. 1 through 3, and duplicate descriptions thereof may be omitted.

Referring to FIG. 4, a wafer image G1 may include an image generated by measuring the wafer WF by using the measurement device 200 in FIG. 1. For example, the wafer image G1 may include an image for indicating information about the diameter of the channel hole. In some example embodiments, the wafer WF may mean the wafer WF after the HAR etching process is performed in the semiconductor process for producing semiconductor products. The plurality of channel holes may be formed in the wafer WF, and each of the channel holes may have different CD values from another.

The system 100 may visualize and output the first measurement case HC1 as a continuous probability distribution, generate a GMM model, and extract noise information, based on the values of each measurement case included in the measurement data set. This issue is described below with reference to FIGS. 5A through 5C.

The wafer image G1 illustrated in FIG. 4 may include an image corresponding to the measurement case generated by the measuring of the wafer WF by using the measurement device 200. Hereinafter, it is assumed that the wafer image G1 illustrated in FIG. 4 includes an image corresponding to the first measurement case HC1.

The points illustrated in the wafer image G1 of FIG. 4 may mean the channel holes formed in each of a first direction and a second direction in the wafer WF. The wafer image G1 may include a first region AR1, a second region AR2, and a third region AR3. In addition, diameters of the channel holes formed in the wafer WF may have different values from each other.

The channel holes in the first region AR1 may include inner holes or dummy holes. In some example embodiments, it is assumed that the first GMM corresponding to the image in FIG. 4 is generated. In this case, the CD values of channel holes in the first region AR1 may correspond to the first Gaussian model.

The channel holes in the second region AR2 and the third region AR3 may include outer holes. In some example embodiments, it is assumed that the first GMM corresponding to the image in FIG. 4 is generated. In this case, the CD values of channel holes in the second region AR2 and the third region AR3 may correspond to the second Gaussian model.

In some example embodiments, the number of channel holes in the second region AR2 and the third region AR3 may be less than the number of channel holes in the first region AR1. Accordingly, by applying weights considering this issue, the noise synthesizing unit 123a of FIG. 2 may reflect the weights when performing the inverse transform. For example, the weight may be applied as 1 to the channel holes corresponding to the first area AR1, and the weight may be applied as 3 to the channel holes corresponding to the second area AR2 and the third area AR3. Accordingly, the ratio of the number of channel holes corresponding to the second area AR2 and the third area AR3 over the number of channel holes corresponding to the first area AR1 may be matched.

FIGS. 5A through 5C are diagrams of a method of extracting the noise information from the measurement data, according to some example embodiments. FIGS. 5A through 5C are diagrams to describe that the system 100 generates the GMM model corresponding to the first measurement case HC1 included in the measurement data set HDS, extracts noise information based thereon, and synthesizes the extracted noise information with the simulation output case to create the noise simulation case. FIGS. 5A through 5C may be described with reference to FIGS. 1 through 4, and duplicate descriptions thereof may be omitted.

FIG. 5A illustrates a first measurement case graph HG1, in which the first measurement case HC1 is visualized as a continuous probability distribution. The first measurement case graph HG1 may include a graph representing the wafer image G1 and a second graph G2 in FIG. 4 as a continuous probability distribution.

In some example embodiments, the first measurement case graph HG1 may include a graph representing CD values of channel holes, and information about the number or density of channel holes having the CD values corresponding thereto.

FIG. 5B is a diagram illustrating that the system 100 generates the first GMM corresponding to the first measurement case graph HG1 in FIG. 5A. The system 100 may generate the first GMM by performing an EM algorithm on the first measurement case HC1. The first GMM may include a first Gaussian model GM1 and a second Gaussian model GM2. The system 100 may extract noise information corresponding to the first GMM.

In some example embodiments, the first Gaussian model GM1 may correspond to a probability distribution for channel holes in the first area AR1 in FIG. 4.

In some example embodiments, the second Gaussian model GM2 may correspond to a probability distribution for channel holes in the second area AR2 and the third area AR3 in FIG. 4. In this case, referring to FIG. 4, because the number of channel holes in the second area AR2 and the third area AR3 is less than the number of channel holes in the first area AR1, the system 100 may adjust the ratio of the first Gaussian model GM1 over the second Gaussian model GM2 by reflecting the weights.

FIG. 5C illustrates a graph, in which the noise information extracted from FIG. 5B and the first simulation output case included in the simulation output data set SODS are synthesized. In other words, the graph of FIG. 5C may be referred to as a result of adding the noise information of the measurement case to the value of first simulation output case.

In some example embodiments, when the average value and the standard deviation value of the first Gaussian model GM1 are adjusted according to the first output value included in the first simulation output case, and when the average value and the standard deviation value of the second Gaussian model GM2 are adjusted according to the first output value included in the first simulation output case, first distribution information may be generated. Accordingly, a first adjusted Gaussian model AGM1 may include the first Gaussian model GM1 adjusted to match the first distribution information. A second adjusted Gaussian model AGM2 may include the second Gaussian model GM2 adjusted to match the first distribution information.

FIG. 6 is a flowchart of a method of augmenting data, according to some example embodiments. The diagram illustrates that the system 100 of FIG. 1 operates in the first mode to generate synthesized data. FIG. 6 may be described with reference to FIGS. 1 and 2, and duplicate descriptions thereof may be omitted.

In operation S110, the system 100 may obtain the simulation input data set SIDS and the measurement data set HDS. In some example embodiments, the simulation input data set SIDS may be generated by sampling the data augmentation module 120a from the simulation recipe information SRI. In some example embodiments, the simulation input data set SIDS may be input from the outside. In some example embodiments, the measurement data set HDS may be generated by measuring the wafer WF by using the measurement device 200. In this case, the measurement data set HDS may be generated by measuring one wafer, or may be generated by measuring several wafers.

In operation S120, the system 100 may obtain (e.g., generate) the simulation output data set SODS by performing a simulation based on the simulation input data set SIDS. In some example embodiments, the system 100 may simulate each simulation input case included in the simulation input data set SIDS by using the simulation module 110, and generate the simulation output data set SODS. The simulation module 110 may transfer the simulation output data set SODS to the data augmentation module 120a.

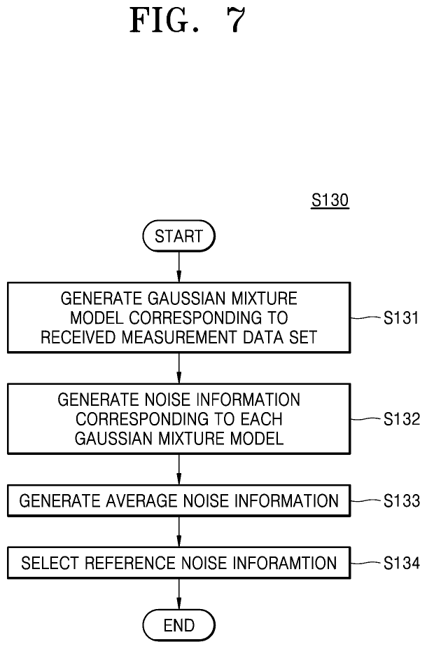

In operation S130, the system 100 may extract noise information of the measurement data set HDS from the measurement data set HDS. In some example embodiments, the system 100 may calculate each measurement case included in the measurement data set HDS by using Formula 1 and Formula 2 by using the data augmentation module 120a, and extract the noise information. The reference noise information GLS may be extracted from the measurement data set HDS. Detailed descriptions of operation S130 are given below with reference to FIG. 7.

In operation S140, the system 100 may synthesize the noise information extracted in operation S130 with the simulation output data set SODS, and extract the distribution information for each simulation output case included in the simulation output data set SODS. In some example embodiments, the system 100 may respectively synthesize simulation output cases included in the reference noise information GLS and the simulation output data set SODS according to Formula 3 and Formula 4 by using the noise synthesizing unit 123a, and generate the simulation distribution information corresponding to each simulation output case.

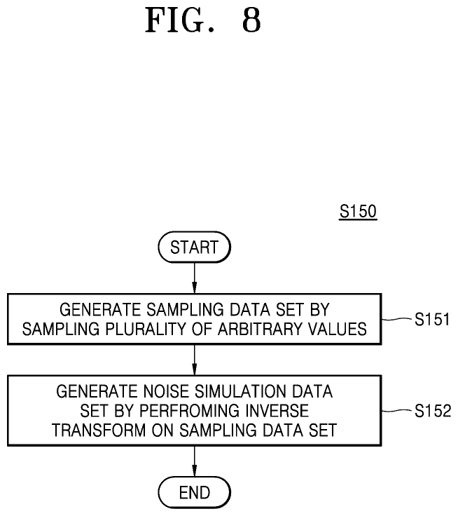

In operation S150, the system 100 may generate the noise simulation data set based on the distribution information generated in operation S140. Detailed descriptions of operation S150 are given below with reference to FIG. 8.

In operation S160, the system 100 may synthesize the simulation input data set SIDS, the noise simulation data set, and the measurement data set HDS, and generate the synthesized data set ADS.

In operation S170, the learning system 300 may utilize the synthesized data set as training data to generate (e.g., train) a machine learning model that includes a semiconductor process design model, also referred to as one or more artificial intelligence models, one or more design models, or the like. In some example embodiments, operation S170 may be referred to as training the machine learning model, training the learning system 300, or the like.

In some example embodiments, the generated one or more process design models may utilize, as an input (e.g., one or more input variables), semiconductor process recipe information that may be used as operation parameters to control manufacturing equipment to perform a semiconductor process. Such process recipe information may include, for example, amounts of various certain types of gases to be injected into a chamber holding a wafer WF to at least partially implement an HAR etching process. The generated one or more process design models may indicate, as an output, one or more properties of a design for a semiconductor product to be at least partially manufactured according to a semiconductor process (e.g., channel hole CD values for channel holes of the semiconductor product formed via the semiconductor process, inter-cell spacing of a semiconductor pattern of the semiconductor product formed via the semiconductor process, thin film thickness of at least a portion of the semiconductor product formed via the semiconductor process, or the like).

In some example embodiments, the generated one or more process design models may utilize, as an input (e.g., one or more input variables), one or more properties of a design for a semiconductor product to be at least partially manufactured according to a semiconductor process (e.g., channel hole CD values for channel holes of the semiconductor product formed via the semiconductor process, inter-cell spacing of a semiconductor pattern of the semiconductor product formed via the semiconductor process, thin film thickness of at least a portion of the semiconductor product formed via the semiconductor process, or the like). The generated one or more process design models may indicate, as an output, semiconductor process recipe information that may be used as operation parameters to control manufacturing equipment to perform a semiconductor process. Such process recipe information may include, for example, amounts of various certain types of gases to be injected into a chamber holding a wafer WF to at least partially implement an HAR etching process.

The generating (e.g., the training) at operation S170 may include applying a learning algorithm to the synthesized data set to create an output algorithm, for example an artificial intelligence model, a “process design model,” or the like, as described herein. Operation S170 may include implementing an artificial neural network that is trained on the synthesized data set generated by the system 100 as a set of training data by, for example, a supervised, unsupervised, and/or reinforcement learning model, and wherein operation S170 may include processing a feature vector to provide output based upon the training. As described herein the artificial neural networks may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but are not limited to the above examples. The artificial intelligence model may include, in addition or alternatively, software structures in addition to hardware structures. Alternatively or additionally, operation S170 may include implementing other forms of artificial intelligence and/or machine learning based on the learning data, such as, for example, linear and/or logistic regression, statistical clustering, Bayesian classification, decision trees, dimensionality reduction such as principal component analysis, and expert systems; and/or combinations thereof, including ensembles such as random forests. Herein, an artificial neural network may have any structure that is trainable, e.g., with learning data that is used as training data.

In operation S180, the process design model is used to generate a semiconductor process design based on applying the design model to one or more input variables. For example, in example embodiments where the process design model generated at operation S170 determines semiconductor product design information as an output based on utilizing semiconductor process recipe information as an input, operation S180 may include applying the process design model to input variables that include semiconductor process recipe information to determine semiconductor product design information to at least partially develop a semiconductor process design. Such a design information determination might be iteratively performed (e.g., where the semiconductor recipe information such as an amount of certain gases used in an HAR etching process may be iteratively adjusted to adjust the semiconductor product design information, such as CD values) until the semiconductor product design information at least meets one or more threshold values. In another example, in example embodiments where the process design model generated at operation S170 determines semiconductor process recipe information (e.g., amounts of certain gases to inject in an HAR etching process) as an output based on utilizing semiconductor product design information (e.g., CD values) as an input, operation S180 may include applying the process design model to input variables that include semiconductor product design information to determine semiconductor process recipe information to at least partially develop a semiconductor process design.

In operation S190, the semiconductor process design, which may include semiconductor product design information and/or semiconductor process recipe information (e.g., including one or more process operational parameters) determined at operation S180 using the process design model is provided to manufacturing equipment to cause the manufacturing equipment to perform one or more semiconductor processes (e.g., HAR etching) on a wafer WF to at least partially manufacture the semiconductor product having the one or more desired properties of the semiconductor product design information, such as a CD value of the channel hole to be formed in the semiconductor product to achieve the desired properties of the semiconductor product design information, or the like.

As described above, the semiconductor products (e.g., semiconductor devices) manufactured based on a semiconductor design that is generated using a design model which is trained using the synthesized data set ADS, which may include a greater amount of training data than measurement data HDS while still reflecting the noise present in the measurement data HDS, may have improved reliability, reduced defects (e.g., reduced deviation from the desired design input variables), or the like based on the design model being trained using the synthesized data set which is an augmented training data.

FIG. 7 is a flowchart of a method of extracting the reference noise information GLS from the measurement data, according to some example embodiments. FIG. 7 is a diagram for describing operation S130 in FIG. 6 in more detail. FIG. 7 may be described with reference to FIG. 1 to FIG. 6, and duplicate descriptions thereof may be omitted.

In operation S131, the system 100 may generate a Gaussian mixture model corresponding to the obtained measurement data set. In some example embodiments, the system 100 may generate the Gaussian mixture models respectively corresponding to the measurement cases included in the measurement data set HDS by using the noise information extraction unit 122a.

In operation S132, the system 100 may extract the noise information corresponding to each Gaussian mixture model. In this case, the noise information may include a gamma value and a lambda value. In some example embodiments, the system 100 may obtain the noise information by calculating gamma values and lambda values for each Gaussian mixture model generated in operation S131 by using Formula 1 and Formula 2 described above, by using the noise information extraction unit 122a.

In operation S133, the system 100 may extract the average noise information. In some example embodiments, the system 100 may extract the average noise information by calculating an average value of gamma values and lambda values extracted from the measurement data set HDS by using the noise information extraction unit 122a.

In operation S134, the system 100 may select the reference noise information GLS. In some example embodiments, the system 100 may select the noise information corresponding to any one GMM of the average noise information and the noise information corresponding to each GMM, by using the noise information extraction unit 122a. The noise information extraction unit 122a may set the selected noise information as reference noise information GLS.

FIG. 8 is a flowchart of a method of generating the noise simulation data set, according to some example embodiments. FIG. 8 is a diagram for describing operation S150 in FIG. 6 in more detail. FIG. 8 may be described with reference to FIG. 1 to FIG. 6, and duplicate descriptions thereof may be omitted.

In operation S151, the system 100 may generate the sampling data set PDS. In some example embodiments, the system 100 may generate the sampling data set PDS by using the sampling unit 121a. In this case, the system 100 may sample a plurality of values by using the QMC sampling method.

In operation S152, the system 100 may perform the inverse transform so that the sample values included in the sampling data set PDS match the distribution information generated in operation S140. The system 100 may generate the noise simulation data set by performing inverse transform. In some example embodiments, the system 100 may perform the inverse transform considering the weight for the Gaussian model.

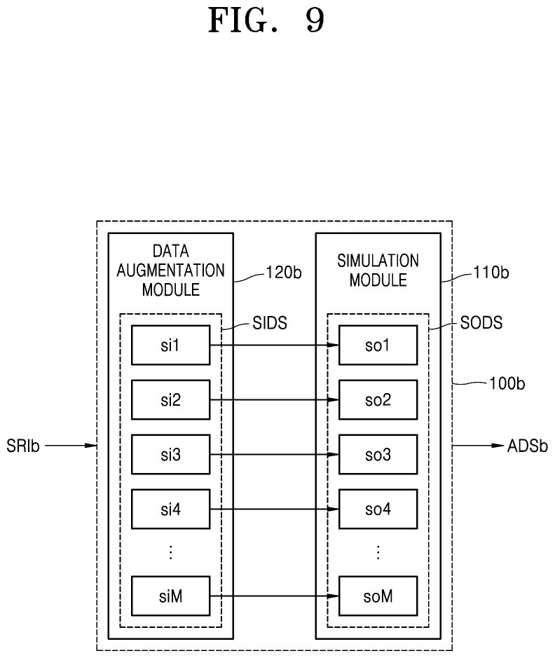

FIG. 9 is a block diagram of a system 100b according to some example embodiments. FIG. 9 illustrates that the system 100b operates in the second mode to generate the synthesized data. FIG. 9 may be described with reference to FIGS. 1 and 2, and duplicate descriptions thereof may be omitted.

The system 100b of FIG. 9 may correspond to the system 100 of FIG. 1. The system 100b may include a simulation module 110b and a data augmentation module 120b. The simulation module 110b in FIG. 9 may correspond to the simulation module 110 in FIG. 1. The data augmentation module 120b in FIG. 9 may correspond to the data augmentation module 120 in FIG. 1. The simulation module 110b and the data augmentation module 120b may be implemented as hardware or software.

The system 100b may obtain simulation recipe information SRIb from the outside. In some example embodiments, the simulation recipe information SRIb may include information about input variables and output variables, which are necessary to simulate the process performed during the semiconductor product production, and may further include information about the sampling range, the sampling method, and the number of sample values of the input variable, which is information necessary for sampling the simulation data.

Hereinafter, it is assumed that the simulation recipe information SRIb includes information about two input variables. In this case, it is assumed that the data augmentation module 120b samples the input values for the first input variable. The remaining second input variable may have a fixed value. In other words, all simulation input cases included in the simulation input data set SIDS may have a first value as a value corresponding to the second input variable. It is an example to sample only one input variable, and it may be certainly possible to sample input values for a plurality of input variables. In some example embodiments, a second value, which is a fixed value for the second input variable, may include a value previously input to the simulation recipe information SRIb, or a value input by a user.

The data augmentation module 120b may sample the input values based on the sampling range and the number of sample values included in the simulation recipe information SRIb. According to the number information of the sample values included in the simulation recipe information SRIb, it is assumed that the number of sampled input values is M (M≥1). Accordingly, the simulation input data set SIDS may include M simulation input cases. Each of the M simulation input cases may correspond to first through M^{th} input values si1 through siM. For example, a value corresponding to the first input variable of the first simulation input case may include the first input value si1, and a value corresponding to the M^{th} input variable of the M^{th} simulation input case may include the M^{th} input value siM. The first input value si1 through the M^{th} input value siM may include values sampled by the QMC sampling method. The use of the QMC sampling method as a sampling method is an example, and the sampling may be performed by using various sampling methods, such as an LHS method or a MC sampling method.

In some example embodiments, when the first input variable is known to match a uniform distribution, the sampling range information may include information indicating a section such as [a, b]. In this case, a and b may mean real numbers. Information about the values a and b may be arbitrarily input by the user, or a particular value known to one of skill in the art may be input as the information about the values a and b.

In some example embodiments, when the first input variable is known to match a Gaussian distribution, the sampling range may be replaced by an average value and a standard deviation value of the Gaussian distribution. In this case, an average value and a standard deviation value of a Gaussian distribution may be arbitrarily input by the user, or a particular value known to one of skill in the art may be input as the average value and a standard deviation value of a Gaussian distribution.

The simulation module 110b may obtain the simulation input data set SIDS from the data augmentation module 120b, perform a simulation based on the obtained simulation input data set SIDS, and as a result, the simulation output data set SODS may be generated. In some example embodiments, the simulation module 110b may generate the simulation output data set SODS by executing the TCAD simulation.

The system 100b may generate a synthesized data set ADSb, by combining the simulation input data set SIDS and the simulation output data set SODS. In other words, the system 100b may randomly adjust the first input variable, and augment the data used for the semiconductor simulation.

FIG. 10 is a flowchart of a method of augmenting data, according to some example embodiments. FIG. 10 illustrates that the system 100b operates in the second mode to generate the synthesized data. FIG. 10 may be described with reference to FIGS. 1, 2, and 9, and duplicate descriptions thereof may be omitted.

In operation S210, the system 100b may obtain the simulation recipe information SRIb.

In operation S220, the system 100b may generate the simulation input data set SIDS, based on the information included in the simulation recipe information SRIb. In some example embodiments, the system 100b may generate the simulation input data set SIDS by sampling input values by using the QMC sampling method via the data augmentation module 120b.

In operation S230, the system 100b may execute a simulation by using the simulation input data set SIDS. The system 100b may generate the simulation output data set SODS corresponding to the result of simulation execution.

In operation S240, the system 100b may generate the synthesized data set ADSb, by combining the simulation input data set SIDS and the simulation output data set SODS.

In operation S270, the synthesized data set ADSb is applied to train a machine learning model (e.g., design model), for example where the simulation input data set SIDS is applied as training input data to a learning algorithm (e.g., using an artificial intelligence network) and the simulation output data set SODS is applied as training input data to the learning algorithm (e.g., using an artificial intelligence network). In operation S280, the design model is applied to input variables (e.g., semiconductor process recipe information) to generate a semiconductor product design having one or more properties (e.g., channel hole CD values). In operation S290, the semiconductor product design and/or the semiconductor process recipe information corresponding thereto in the design model are provided to manufacturing equipment to cause the manufacturing equipment to perform one or more semiconductor processes to at least partially manufacture a semiconductor product having the semiconductor product design.

Operations S270, S280, and S290 of FIG. 10 correspond to operations S170, S180, and S190 as described with regard to FIG. 6, where the design model is generated at operation S170 of FIG. 10 based on the synthesized data set that is generated at operation S240.

FIG. 11 is a flowchart of a method of augmenting data, according to some example embodiments. The diagram illustrates that the system 100 operates in the third mode to generate synthesized data. FIG. 11 may be described with reference to FIGS. 6 and 10, and duplicate descriptions thereof may be omitted.

The system 100 may augment data by executing in parallel the method of augmenting data in the first mode of FIG. 6 and the method of augmenting data in the second mode of FIG. 10. In this case, it may be described that the system 100 operates in the third mode. In some example embodiments, operations S300 and S400 may be performed simultaneously.

In operation S300, the system 100 may generate first synthesized data by operating in the first mode according to operations S110 through S160 in FIG. 6.

In operation S400, the system 100 may generate second synthesized data by operating in the second mode according to operations S210 through S240 in FIG. 10.

In operation S500, the system 100 may generate a third synthesized data set by combining the first synthesized data set and the second synthesized data set.

FIG. 12 is a block diagram of a system 1000 according to some example embodiments. The system 1000 of FIG. 12 may correspond to (e.g., may implement) the system 100 of FIG. 1, the learning system 300 of FIG. 1, the design system 400 of FIG. 1, the manufacturing equipment 500 of FIG. 1, or any combination thereof. FIG. 12 may be described with reference to FIG. 1, and duplicate descriptions may be omitted.

As illustrated in FIG. 12, the system 1000 may include a processor 1100, a graphics processor 1200, a neural network processor 1300, an accelerator 1400, an input/output (I/O) interface 1500, a memory subsystem 1600, a storage 1610 and a bus 1700. The processor 1100, the graphics processor 1200, the neural network processor 1300, the accelerator 1400, the I/O interface 1500, and the memory subsystem 1600 may communicate with each other via the bus 1700. In some example embodiments, the system 1000 may include an SoC, in which components are implemented on one chip, and the storage 1610 may be arranged outside the SoC. In some example embodiments, at least one of the components illustrated in FIG. 12 may also be omitted from the system 1000.

The processor 1100 may control the operation of the system 1000 at the uppermost layer, and may control other components of the system 1000. The processor 1100 may communicate with the memory subsystem 1600, and execute instructions. In some example embodiments, the processor 1100 may execute a program stored in the memory subsystem 1600. The program may include a series of instructions. Processor 1100 may include any hardware, which may execute instructions independently, and may be referred to as an application processor (AP), a communication processor (CP), a central processing unit (CPU), a processor core, a core, etc.

The graphics processor 1200 may execute instructions related to graphic processing, and provide, to the memory subsystem 1600, data generated by processing data obtained from the memory subsystem 1600.

The neural network processor 1300 may be designed to process operations based on artificial neural networks at a high speed, and may enable functions based on artificial intelligence (AI). Artificial neural networks that the neural network processor 1300 may be configured to implement may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but are not limited to the above examples. The artificial intelligence model may include, in addition or alternatively, software structures in addition to hardware structures. Alternatively or additionally, the neural network processor 1300 may implement other forms of artificial intelligence and/or machine learning based on the learning data, such as, for example, linear and/or logistic regression, statistical clustering, Bayesian classification, decision trees, dimensionality reduction such as principal component analysis, and expert systems; and/or combinations thereof, including ensembles such as random forests. Herein, an artificial neural network may have any structure that is trainable, e.g., with learning data that is used as training data.

In some example embodiments, the processor 1100, the graphics processor 1200, and the neural network processor 1300 may include two or more processing cores. As described above with reference to the drawings, the processor 1100 may execute the simulation module and the data augmentation module according to the inventive concepts, and as a result, may generate synthesized data.

The accelerator 1400 may be designed to perform a designated function at a high speed. For example, the accelerator 1400 may provide, to the memory subsystem 1600, data generated by processing data obtained from the memory subsystem 1600.

The I/O interface 1500 may provide an interface for obtaining an input from the outside of the system 1000 and providing an output to the outside of the system 1000. For example, the system 1000 may obtain the simulation recipe information and the simulation input data set from the outside.

The memory subsystem 1600 may be accessed by other components connected to the bus 1700. In some example embodiments, the memory subsystem 1600 may include a volatile memory, such as dynamic RAM (DRAM) and static RAM (SRAM), or a non-volatile memory, such as flash memory and resistive RAM (RRAM). In addition, in some example embodiments, the memory subsystem 1600 may provide an interface to the storage 1610. The storage 1610 may include a storage medium which does not lose data even when power is cut off. For example, storage 1610 may include a semiconductor memory device such as a non-volatile memory, or may also include any storage medium, such as a magnetic card/disk and an optical card/disk. The method of augmenting data, according to some example embodiments may be stored in the memory subsystem 1600 or the storage 1610.

The memory subsystem 1600 may be accessed by the processor 1100, and may store software elements executable by the processor 1100. The software elements may include, as non-limiting example, software components, programs, applications, computer programs, application programs, system programs, software development programs, machine programs, operating system (OS) software, middleware, firmware, software modules, routines, subroutines, functions, methods, procedures, software interface, application program interface (API), command sets, computing code, computer code, code segments, computer code segments, words, values, symbols, or a combination of two or more thereof.

The bus 1700 may operate based on one of various bus protocols. The various bus protocol may include at least one of advanced microcontroller bus architecture (AMBA) protocol, universal serial bus (USB) protocol, multi-media card (MMC) protocol, peripheral component interconnect (PCI) protocol, PCI-express (PCI-E) protocol, advanced technology attachment (ATA) protocol, serial-ATA protocol, parallel-ATA protocol, small computer system interface (SCSI) protocol, enhanced small disk interface (ESDI) protocol, integrated drive electronics (IDE) protocol, mobile industry processor interface (MIPI) protocol, or universal flash storage (UFS) protocol.

As described herein, any devices, systems, units, blocks, circuits, controllers, processors, and/or portions thereof according to any of the example embodiments (including, for example, the system 100, the simulation module 110, the data augmentation module 120, the measurement device 200, the learning system 300, the design system 400, the manufacturing equipment 500, the data augmentation module 120a, the sampling unit 121a, the noise information extraction unit 122a, the noise synthesizing unit 123a, the system 100b, the simulation module 110b, the data augmentation module 120b, the system 1000, the processor 1100, the graphics processor 1200, the neural network processor 1300, the accelerator 1400, the I/O interface 1500, the memory subsystem 1600, the storage 1610, any portion thereof, or the like) may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid-state drive memory device, storing a program of instructions, and a processor (e.g., CPU) configured to execute the program of instructions to implement the functionality and/or methods performed by some or all of any devices, systems, units, blocks, circuits, controllers, processors, and/or portions thereof according to any of the example embodiments.

While the inventive concepts have been particularly shown and described with reference to some example embodiments thereof, it will be understood that various changes in form and details may be made therein without departing from the spirit and scope of the following claims.

What is claimed is:

1. A method of augmenting training data for a semiconductor process modeling, the method comprising:
obtaining a simulation input data set and a measurement data set;
obtaining a simulation output data set generated based on performing a simulation based on the simulation input data set;
extracting reference noise information associated with the measurement data set from the measurement data set;
extracting distribution information associated with each simulation case included in the simulation output data set based on synthesizing the reference noise information and the simulation output data set;
generating a noise simulation data set based on sampling data based on the distribution information; and
generating a synthesized data set based on synthesizing the simulation input data set, the noise simulation data set, and the measurement data set.

2. The method of augmenting training data of claim 1, wherein the simulation comprises technology computer aided design (TCAD) simulation, and
the generating of the simulation output data set comprises generating the simulation output data set based on performing the TCAD simulation based on the simulation input data set.

3. The method of augmenting training data of claim 1, wherein the simulation input data set comprises input cases sampled according to at least one of a Monte Carlo sampling method, a Latin hypercube sampling method, or a quasi-Monte Carlo sampling method.

4. The method of augmenting training data of claim 1, wherein the extracting of the reference noise information comprises:
generating Gaussian mixture models respectively corresponding to measurement cases included in the measurement data set;
generating pieces of noise information respectively corresponding to the Gaussian mixture models; and
generating average noise information from the pieces of noise information, and
wherein the reference noise information is selected from the pieces of noise information and the average noise information.

5. The method of augmenting training data of claim 4, wherein each piece of the pieces of noise information comprises:
a gamma value, which is a ratio of a first average value of a measurement case corresponding to each of the pieces of noise information over a second average value of the Gaussian mixture model of the Gaussian mixture models that corresponds to the each piece of noise information; and
a lambda value, which is a ratio of a first standard deviation value of the Gaussian mixture model corresponding to the each piece of noise information over the second average value.

6. The method of augmenting training data of claim 5, wherein the distribution information comprises:
a third average value calculated based on an output value of each simulation case included in the reference noise information and the simulation output data set; and
a second standard deviation value calculated based on the reference noise information and the second average value.

7. The method of augmenting training data of claim 6, wherein the generating of the noise simulation data set comprises:
generating a sampling data set based on sampling a plurality of arbitrary values; and
generating the noise simulation data set based on performing an inverse transform on the sampling data set based on the distribution information.

8. The method of augmenting training data of claim 7, wherein the sampling data set comprises values sampled based on using a quasi-Monte Carlo sampling method based on a Sobol sequence.

9. The method of augmenting training data of claim 1, wherein the simulation input data set comprises values of injection amounts of gases used in a high aspect ratio (HAR) etching process on a wafer, and
wherein the simulation output data set
comprises critical dimension (CD) values of channel holes obtained based on performing technology computer aided design (TCAD) simulation corresponding to the simulation input data set.

10. The method of augmenting training data of claim 4, wherein the measurement data set comprises:
measurement injection amounts of gases used in a high aspect ratio (HAR) etching process on a wafer; and
measurement critical dimension (CD) values of a plurality of channel holes corresponding to the measurement injection amounts.

11. The method of augmenting training data of claim 10, wherein the Gaussian mixture models comprises:
a first Gaussian model representing a distribution of the CD values corresponding to inner holes and dummy holes of the plurality of channel holes; and
a second Gaussian model representing a distribution of the CD values corresponding to outer holes of the plurality of channel holes.

12. A computer-readable non-transitory storage medium configured to store instructions executable by a processor to cause the processor to perform training data augmentation for semiconductor process modeling, wherein the training data augmentation for the semiconductor process modeling comprises:
obtaining simulation recipe information;
generating a first simulation input data set based on sampling values corresponding to input variable information included in the simulation recipe information;
generating a first simulation output data set based on performing simulation based on the first simulation input data set; and
generating a first synthesized data set based on synthesizing the first simulation input data set and the first simulation output data set.

13. The computer-readable non-transitory storage medium of claim 12, wherein the first simulation input data set comprises a plurality of values sampled based on using a quasi-Monte Carlo sampling method.

14. The computer-readable non-transitory storage medium of claim 12, wherein the training data augmentation for the semiconductor process modeling further comprises:
obtaining a second simulation input data set and a measurement data set;
obtaining a second simulation output data set based on performing simulation based on the second simulation input data set;
extracting reference noise information associated with the measurement data set from the measurement data set;
extracting distribution information associated with each simulation case included in the second simulation output data set based on synthesizing the reference noise information and the second simulation output data set;
generating a noise simulation data set based on sampling data based on the distribution information;
generating a second synthesized data set based on synthesizing the second simulation input data set, the noise simulation data set, and the measurement data set; and
generating a third synthesized data set based on synthesizing the first synthesized data set and the second synthesized data set.

15. The computer-readable non-transitory storage medium of claim 12,
wherein the simulation recipe information comprises information associated with types of gases used in a high aspect ratio (HAR) etching process on a wafer, and
the input variable information comprises information indicating an injection amount of any one gas of the gases used in the HAR etching process.

16. A system for augmenting training data for a semiconductor process modeling, the system comprising:
a memory configured to store a program for augmenting the training data; and
a processor configured to execute the program to
obtain a first simulation input data set and a measurement data set;
obtain a first simulation output data set based on performing simulation based on the first simulation input data set;
extract reference noise information associated with the measurement data set from the measurement data set;
extract distribution information associated with each simulation case included in the first simulation output data set based on synthesizing the reference noise information and the first simulation output data set;
generate a noise simulation data set based on sampling data based on the distribution information; and
generate a first synthesized data set based on synthesizing the first simulation input data set, the noise simulation data set, and the measurement data set.

17. The system of claim 16,
wherein the processor generates Gaussian mixture models respectively corresponding to measurement cases comprised in the measurement data set,
generates pieces of noise information respectively corresponding to the Gaussian mixture models, and
generates average noise information from the pieces of noise information, and
wherein the reference noise information is selected from the pieces of noise information and the average noise information.

18. The system of claim 17, wherein each piece of the pieces of noise information comprises:
a gamma value, which is a ratio of a first average value of a measurement case corresponding to the each piece of noise information over a second average value of the Gaussian mixture model of the Gaussian mixture models that corresponds to the each piece of noise information; and
a lambda value, which is a ratio of a first standard deviation value of the Gaussian mixture model corresponding to the each piece of noise information over the second average value.

19. The system of claim 18, wherein the distribution information comprises:
a third average value calculated based on an output value of each simulation case included in the reference noise information and the first simulation output data set; and
a second standard deviation value calculated based on the reference noise information and the second average value.

20. The system of claim 16, wherein the processor is configured to
obtain simulation recipe information and an input variable,
generate a second simulation input data set based on sampling values corresponding to the input variable, based on the simulation recipe information,
generate a second simulation output data set based on performing simulation based on the second simulation input data set,
generate a second synthesized data set based on synthesizing the second simulation input data set and the second simulation output data set; and
generate a third synthesized data set based on combining the first synthesized data set and the second synthesized data set.
